(19) United States
(12) Patent Application Publication
(10) Pub. No.: US 2011/0313780 A1
(43) Pub. Date: Dec. 22, 2011

(54) Method for acquiring information from various parties, for preserving and perpetuating said information and for making it available to descendants and future generations for their use

(76) Inventor: Gelu Comanescu, Washington, DC (US)

(21) Appl. No.: 13/107,890

(22) Filed: May 14, 2011

Related U.S. Application Data
(60) Provisional application No. 61/345,719, filed on May 18, 2010.
(60) Provisional application No. 61/348,340, filed on May 26, 2010.
(60) Provisional application No. 61/349,867, filed on May 30, 2010.

(51) Int. Cl. G06Q 99/00

(52) U.S. Cl. 705/1.1

(57) ABSTRACT

We present a method for providing a service to various parties (e.g. regular people, institutions, organizations, associations of all kinds) for keeping the information that these parties want (e.g. personal information, medical, journalistic, historic, economical, scientific, technical and concerning any other activity and organization) such that this information is available for the use of future generations and descendants of such parties as far into the future as possible.

### CROSS-REFERENCES TO RELATED APPLICATIONS

Under 35 U.S.C. §119(e), this application claims the benefit of priority of U.S. Provisional Patent Applications filed by inventor Gelu Comanescu as follows: No. 61/345,719 filed on May 18, 2010 (EFS ID 7633741, confirmation number 3975); No. 61348340 filed on May 26, 2010 (EFS ID 7689939, confirmation number 4804); and No. 61349867 filed on May 30, 2010 (EFS ID 7714436, confirmation number 1424). The contents of the provisional application are incorporated by reference in their entirety.

### FIELD OF THE INVENTION

The present invention relates to a method for acquiring information from various parties, for preserving and perpetuating the said information and for making it available to descendants and future generations for their use.

### BACKGROUND OF INVENTION

People have a natural interest in knowing about their ancestors and their lives as far back in the past as possible. Also, information about ancestors' medical history and genetic background is of significant medical value both to individual persons and to the society. Conversely, many people would like to transmit information to their descendants (as far in the future as possible) about their lives and their medical histories because such information is useful to the descendants in particular and to society in general.

For the sake of clarity we will refer to a specific fictional case. Consider John born in year 2000, his descendants Sarah born in year 2100, and Alice born in year 2200. John would like his future generations to know facts about him such as: John was a lawyer who argued six cases in the Supreme Court; he climbed the Himalayas; he liked ancient history and fought for the preservation of ancient Mayan sites; he was married to Mary for 35 years and had children Bob, Bill and Patty. John would like his descendants to see a picture of him with his family and to have a textual description of his life and family. Also, John would like his descendants to know his medical history and to know what his DNA sequence is.

John can write down all of the above information and give it to his son Bill. Thirty years later Bill gives it to his daughter Jane. Then Jane accidentally loses it (or does not care, or dies prematurely, etc.). Jane has 5 kids; her 5 kids each have 3 kids. In year 2100, the 15 descendants of John would like to know about their great-grandfather and there is only some vague information transmitted orally. Currently people keep such information in family albums which are supposed to be transmitted from generation to generation. Unfortunately these family albums tend to lose information as time goes by, are lost, are not transmitted to all descendants, and after a few generations all information may be lost.

Most times people know very little about their ancestors and not very far back because information about ancestors (e.g. great-grandparents) is not kept in an organized manner and is lost over generations. People, generally, do not sit down to write a coherent and somewhat complete description of their lives, hobbies, and health issues, with the purpose of having this description kept and perpetuated for their descendants and future generations to see. Generally, people have family-albums in which they keep pictures of their ancestors (e.g. great-grandparents) but there is very little in terms of written description of the ancestors. Most often information about an ancestor's life is transmitted orally from generation to generation. This oral and non-organized transmission of information leads to the loss of information after only a few generations.

There is also an inherent difficulty in keeping and transmitting information about someone's ancestors: a person born in year 2000 usually has more than 10 ancestors (great-grandparents) that lived around year 1900; more than 40 that lived around year 1850; and more than 100 ancestors that lived around year 1800 (only 200 years ago). Sometimes you hear people saying that they know that their great-great-great grandparents came from Ireland in year 1850. Such information tells only a very small part about someone's ancestry because a regular person has about 50 ancestors that lived in year 1850 (second order great grandparents).

In conclusion, a person born in year 2000 likely has more than 300 ancestors that lived in the last 200 years (since year 1800). Obtaining, keeping, and transmitting information about 300 ancestors obviously poses significant challenges and difficulties. Similarly a person who is born in year 2000 likely will be one of the 300 ancestors of one of his descendants born in year 2200; and one of the about 20 ancestors of a descendant born in year 2100.

Consider again John in the example above. Let's say that he finds out he has a hereditary disease and that he finds the specific genetic sequence in his DNA that causes this disease. He wants to inform all his descendants about this hereditary disease and to insure that they have his DNA genome sequence for their doctor to use. Assume that his intention is to make sure that this information gets transmitted for at least 200 years down the family tree (to Alice born in year 2200). This is very difficult because in year 2200 John may have up to 300 descendants and because he is only one out of the 300 ancestors that Alice has between years 2000 and 2200. It is very likely that information is lost somewhere down the family tree. Anyway, the info that John wants to send to his descendant Alice may not only be interesting to Alice (she likes to know what an interesting guy was John) but may save her life by warning her about a genetic predisposition to a disease and providing her with the genome sequence that may carry that defect.

The legacies of people who are public figures (e.g. the president of the United States), or are outstanding (e.g. Albert Einstein) may be preserved for long periods of time anyway because institutions such as the National Archives take on perpetuating information about these parties. In this application the words “person” and “persons” refer to ordinary human beings as well as to celebrities or people who are public figures or are outstanding in any way.

This invention addresses the need for finding a way to ensure the perpetuation of personal and other information over time to future generations as far into the future as possible and making this information available to the parties interested in obtaining such information at various times in the future. This method offers people an incentive to write down information about themselves in an organized manner and to make a record containing information they want to be transmitted to future generations. Persons who want information about them to be perpetuated and made available to the future generations can use the proposed invention and service to achieve that.

### SUMMARY OF THE INVENTION

(1). The Offer to Provide a Service and the Contractual Agreement.

The party practicing the invention advertises and offers a service to various parties (e.g. people, private parties, institutions, organizations, associations of all kinds) for keeping information (e.g. personal information, medical, journalistic, historic, economical, scientific, technical and concerning any other activity and organization) for the use of future generations and descendants of such parties as far into the future as possible.

The party practicing the invention employs a means for making the following contractual offer to customers with the intention of performing the promise: the party practicing the invention promises to take steps to ensure that the information provided by customers will be kept for the use of future generations (for as long as possible, or for a certain period of time) and to ensure that the kept information will be made available to the future generations according to the customer's specifications (e.g. only to customer's descendants, or health organizations, or any interested party). The above promise is performed upon customer providing the party offering the service with the information that customer wants to be perpetuated and kept for the use of future generations and upon the customer fulfilling other promises such as paying a fee.

Such a means for making an offer includes but is not limited to making an offer over the internet by an on-line service, in newspapers, on television, on the radio, or any other ways. Such a means for entering in such contractual agreement includes but is not limited to a contract signed via an on-line service or via signed paper.

(2). Collection of Information.

The party practicing the invention employs a means for collecting the information from customers with the purpose of keeping and perpetuating it for the use of future generation. The information can be collected in physical or digital form. The collection of information can be done on-line whereas the party offers a website or email address where the customers can upload or send the information in digital form.

The party practicing the invention employs a means for offering customers a template for organizing the information such that the information fits the needs of the customers, is in a form that facilitates the perpetuation of information over long periods of time and facilitates the availability of the information to interested parties in the future. For instance, an internet template may prompt customers to upload a 50,000 character text description of their life and two 40 KB pictures.

(3). Forming Records

The party practicing the invention employs a means for organizing the information from customers into a record such that the record contains the desired information organized in a way suitable to be seen by interested parties in the future. For instance, a record may contain a 50,000 character text and two 40 KB pictures.

The party practicing the invention employs a means of forming a sub-record to each record, whereas the said sub-record contains information that identifies the record (e.g. name, date of birth, residence, parents' names, descendants' names, relatives' names) on the storage media and among all the records such that the interested parties of the future generations can find the record they are interested in seeing (e.g. concerning their ancestors).

(4). Writing the Information on a Physical Media with the Purpose of Perpetuating Said Information.

The party practicing the invention employs a means for recording or writing the information obtained from customers on data storage media such as hard-disks, digital versatile disks (DVDs), compact disks (CDs), written on paper, and any other way of writing and keeping information.

(5). Keeping Track and Finding the Records on the Data-Storage-Media

The party practicing the invention employs a means for keeping track of all the personal records stored on a certain data-storage-media such as a hard-disk. That can be accomplished by forming a record file indexing all the personal records stored on that storage-media. Such record file would indicate identifying information such as the name, date of birth, residence, record index number, and point to the place on the storage media where the specific personal record is written.

(6). Means for Keeping, Preserving and Perpetuating the Information.

The party practicing the invention employs a means for recording the information on types of storage media known to last for long periods of time or designed specifically to ensure survival and perpetuation of the information over long periods of time or any other medium that is fit for such a purpose. For instance, it is believed that hard-disks may last up to 100 years.

The party practicing the invention employs a means for making multiple copies of the information on various types of storage-media such that if one type fails in time the other one survives. This way the survival and perpetuation of the information for a long time is ensured.

The party practicing the invention employs a means for storing the data-storage-media in multiple places (e.g. the U.S. National Archives, Yucca Mountain; a deep oil well; Antarctica; Australia; on the bottom of the ocean; on the moon; send around the galaxy in a spaceship). This way if something happens in a certain part of the world (e.g. natural disasters, political changes, accidents) and storage-media are lost in one part of the world they survive somewhere else.

The party practicing the invention employs various means to keep the data storage media under special conditions such as: under certain temperature and humidity conditions, protected from light and radiation, encapsulated, protected against natural disasters, and using other means, thereby ensuring that the storage-media lasts for a long time and can be used by future generations.

The party practicing the invention periodically checks the storage media for defects and copies the information from old storage media onto new storage media. For instance, if a hard-disk deteriorates in 100 years, then every 75 years the data on an old storage-media will be transferred onto a new storage media. This way after 100 years the information survives even though the original storage media did not survive and the information is perpetuated.

(7). Forming a Record That Indexes all the Data-Storage-Media

The party practicing the invention employs a means for keeping records of where the data-storage-media are stored. As we specified above one of the strategies employed to ensure survival of information is to store multiple copies of the same records on various data-storage-media, in multiple places, and under various conditions. Consequently, a record is necessary to keep track of all these storage-media and places.

(8). Forming Records That Keep and Index All the Records on All Storage-Media Organized by Various Parameters.

The party practicing the invention employs a means for making records of all the records on the storage-media such that individual records can be found as a function of parameters such as: name, family tree, date of birth, residence, index number. Over time a large number of data-storage-media and records will be accumulated. Consequently, it is necessary to find a way to index and organize them as a function of parameters such as name, family tree, date of birth, residence such that interested parties in the future can find the specific records they want (i.e. information about their ancestors). Consider Alice, born in year 2200 in Washington D.C. She would like to find the records of her ancestors born around year 2000. By year 2200, the service will likely administer millions or billions of records, thus Alice has to find the records she is interested in among these millions of records. She can look at the records of her grandparents, which will point to the records of their grandparents and so on as far back as possible. It would be good if the records are organized on family-trees and records of the family-trees are kept. This way Alice can access only the ancestors she needs.

(9). Making the Information Available to Interested Parties at Various Times in the Future.

The party practicing the invention employs a means for keeping copies of the records such that, at any time in the future, interested parties can find the records they are interested in. The records are made available to interested parties upon satisfying conditions such as paying a fee. For instance, if in year 2100 Sarah wants to find her ancestors she needs to be able to access the service and, upon paying a fee, obtain the records of her ancestors. Various strategies can be employed to ensure availability of information to future generations: copies of the records can be provided to Governmental and other organizations such as the National Archives with the provision that the information should be made available for the use of future generations.

The party practicing the invention may promise to take steps towards perpetuation of information even if said party (e.g. corporation, association, organization, private party) does not survive. For instance, the party offering the service may be a corporation which at a certain time in the future goes bankrupt. The storage-media it owns are still valuable assets which can be sold or transferred to someone else. A provision can be added in the contract that if the party practicing the invention does not survive or can no longer preserve and administer the records (i.e. goes bankrupt) the party will transfer the records to whoever is interested and can preserve the records and provide the service.

### DESCRIPTION OF THE PREFERRED EMBODIMENT

In the following we specify the best mode and preferred embodiment for each of the steps described in the Summary of Invention.

(1). The Offer to Provide a Service and the Contractual Agreement.

The party practicing the invention maintains a website where he advertises and offers a service to various customers or interested parties (such as private persons, private parties, institutions, organizations, associations of all kinds), whereas he keeps information (e.g. personal information, medical, journalistic, historic, economical, scientific, technical and concerning any other activity and organization) that the customer indicates such that the information is available for the use of future generations and descendants of such parties as far into the future as possible.

On this website the party practicing the invention makes a contractual offer to customers. The party practicing the invention promises to take the steps described below (sections 2-4) to ensure that the information provided by the customer will be kept for the use of future generations (as long as possible, or for a certain period of time) and to ensure that the kept information will be made available to the future generations according to customer's specifications (e.g. only to customer's descendants, or health organizations, or any interested party). The above promise may be performed in consideration for the payment of a fee by the customer. The customer provides the party offering the service with the information that the customer wants to be kept and perpetuated for the use of future generations.

(2). Collection of Information:

The website administered by the party practicing the invention offers customers a way to submit the information they want kept by uploading files or filling out a template. The party practicing the invention collects and stores the information submitted by customers. For instance, a template on the website would prompt customers to upload a 50,000 character text (about 50 pages) describing whatever the customer wants to be transmitted to his or her descendants and future generations (e.g. life, hobbies, medical records, profession) and to submit two 40 KB pictures. All this information is organized in a record file corresponding to each customer and stored on a storage media such as a hard-disk.

The record may contain various types of information in various formats: text, pictures, medical and genetic information such as DNA sequence.

A customer can store in one single record all the information about him or her (text, pictures, medical information, his DNA sequence). Also a customer may choose to store different information on different records. For instance, personal information can be held on one record while medical and DNA sequence information can be held on another record. A person may choose to invest more money in perpetuating his medical and genetic record than his personal life record.

Records may be modified (information added, changed, deleted) at the request of the customer and according to the agreement.

Information necessary to better perpetuate the record, such as to help descendants in the future find the record and identify it with the right ancestor, and to correctly place the person on the family tree, is entered in a separate part of the record that has the specific purpose of helping identify the record holder. This record item will contain entries such as: name, date and place of birth, names of family members, names of relatives, the personal information of related parties, place of residence etc.

A reasonably detailed record holding 50 pages of text and two pictures would easily fit on 100 KB of memory. Consequently, a 100 GB hard-disk (like the one in a regular laptop) would hold 1 million such records. A person may choose to pay more money for more information stored and for more effort invested in perpetuating such information.

Collection of information can also be done in physical form (written on paper) and the service provider may convert the information into the desired format (e.g. digital format).

(3). Ensuring Survival and Perpetuation of the Information.

The records will be stored on data storage media that are known to last a long time. For instance, it is believed that hard-disks last for close to 100 years. New data storage media will be specifically designed to last for a very long time. The data storage media will be kept and stored under conditions that ensure the preservation of said data storage media. Multiple copies (e.g. 20 copies) of the records will be made and will be stored on different data storage units such that if one of the data storage units fails the others survive. The multiple copies will be stored on various types of data storage media (e.g. hard-disks, CDs, DVDs, permanent memory) such that if one type of data storage media fails the information survives on other types of storage media. Each data storage unit (carrying one copy of said information and records) will be stored in a different place on the earth and in the universe such as: the United States National Archives, Yucca Mountain, a deep oil well, Antarctica, Australia, on the bottom of the ocean, on the moon, etc. Each data storage media will be encapsulated and kept under special environmental conditions (e.g. as relating to temperature, humidity, radiation) to prolong its survival in time.

Various means, strategies, and levels of sophistication and expense can be implemented to ensure that the information and records survive for a long time. Various levels of efforts, expense and means can be used to ensure survival of information. Consequently, the more financial resources and efforts are invested the more likely that the record will survive a longer time and the more likely the record will be accessible to future interested parties.

An accounting system to keep track of all the hard-disks and their characteristics (year fabricated, type, time expected to last, format of information stored) is implemented such that the hard-disks are copied onto a new data storage unit or media every period of years (e.g. 50 years) thus prolonging the survival of information.

Each storage media will have a record indexing and identifying all the records it holds based on the name of the people and their placement on the family tree. Each person will be placed in a family tree record and the family tree is kept in a separate record.

The service also, may store information (and form records corresponding to this information) about parties that lived in the past, wherein said information is provided by other parties or other services (e.g. records posted on Ancestry.com). For instance, a person living in year 2016 may request to store a record containing information about his great-grandparents who came from Europe in year 1890.

(4). Ensuring Availability of the Stored Records to Interested Parties in the Future

The party practicing the invention will make the information available to interested parties in the future. Various strategies are employed to ensure availability of information to future generations. Copies of the records are provided to Governmental and other organizations such as the United States National Archives with the provision that the information should be made available for the use of future generations.

As we specified above one of the strategies employed to ensure survival of information is to store multiple copies of the same records on various storage media, in multiple places, and under various conditions. Consequently, a record is necessary to keep track of all these storage-media and places where they are stored. Records of the places where various storage-media are stored (e.g. Australia, Yucca Mountain, Antarctica) will be kept.

Over time a large number of records will accumulate. Consequently, it is necessary to find a way to index and organize them as a function of parameters such as name, family tree, date of birth, and residence. Records will be kept with all the records on the storage-media such that individual records can be found as a function of parameters such as: name, family trees, date of birth, residence, index number.

Readily available copies of the records will be kept such that at any time in the future interested parties can find the records they are interested in. The records are made available (e.g. on-line by downloading) to interested parties upon satisfying conditions such as paying a fee.

In the following we consider two fictional parties: John (75 years old in 2015), and his descendant Alice (born in year 2200) and describe how they would interact with the service:

In the following we explain what actions would John take and how he would interact with the party practicing the invention in year 2015. John would find out about the service and how to access the service either through advertising (e.g. internet, television, newspaper etc.) or by word of mouth. John would go on the service website and read about the details of the service and the agreement. Upon agreement with the offer and after satisfying his part of the agreement (e.g. payment of a fee) John would be prompted to make a record containing the information he wants kept for the use of future generations. The record may contain text files, picture files, DNA sequence files, and other types of files. The record will specifically contain a sub-record with information to be used for identifying John to his descendants and future generations such as: his name, place of birth, birthday, day record was created, name of all his ancestors and relationship type, name of all known descendants and relationship type. Once John completes the record he transfers it to the record administrator (party practicing the invention).

In the following we describe what the service administrator would do with John's record. The administrator would store the record on a computer storage media, such as hard-disks, DVDs, CDs, or other media suitable for keeping records for a long time. The administrator would keep on each such storage media an index to all records kept on the storage-media in a preset way such as to ensure that the future generations can find the desired records. Multiple copies of the records will be kept in various places around the world and various preservation means will be employed. The information is kept in an archive like system such that access is facilitated over the generations.

In the following we describe how Alice, born in year 2200 in Washington D.C. and a descendent of John, would find and use the information about her ancestors. She would like to find the records of all her ancestors since year 2000. She can look at the records of her grandparents, which will point to the records of their grandparents and so on as far back as possible. It would be good if the records are organized on a family-tree and records of the family-trees are kept. This way Alice can access only the ancestors she needs.

There are numerous circumstances that indicate that information kept in this way will be perpetuated over long periods of time: even if the data-storage-media (e.g. hard-disk) degrades over time (e.g. after 100 years) it is very easy and inexpensive to make new copies of the hard-disk and perpetuate the info for another 100 years. It is inexpensive for whoever owns such a hard-disk to keep it safe and make copies of it (perpetuate the info) and he almost certainly will be able to sell to someone the information on such digital storage media and recover its cost. Government organizations (e.g. the National Archives) are interested in keeping such records. The cost of maintaining and perpetuating the information is low and likely much lower than the money its owner can derive from it.

Various types of parties can submit records they need kept such as: private persons (the most interested), organizations, health institutions, companies, political parties, governments, newspapers, scientific organization, religious organizations, and historical organizations.

Such a service and records would be useful to medical research, historians, politicians, scientists, preserving and perpetuating artistic, scientific, political, and philosophical ideas and creations. Many parties that are attracted to the service because they want to leave personal information (pictures and hobbies) to the future generation will also end up submitting health information which may benefit the Society in general.

Although the present invention has been described with respect to the preferred embodiment, numerous modifications and variations can be made and still the result will come within the scope of the invention. No limitation with respect to the specific embodiment disclosed herein is intended or should be inferred.

What is claimed is:

1. A method of keeping and perpetuating information about one or more persons and making said information available to descendants of said persons and to future generations, wherein one or more of the following conditions are satisfied:
(a) said persons know what said information comprises,
(b) said keeping and perpetuating of said information is performed upon request by said persons,
(c) relatives or agents or representatives of said persons know that said information will be perpetuated,
(d) relatives or agents or representatives of said persons know what said information comprises,
(e) said persons are neither celebrities nor public figures,
(f) society does not have any particular reason to keep and perpetuate information about said persons,
(g) society does not have more reasons to keep and perpetuate information about said persons than to keep and perpetuate information about any other person,
(h) said keeping and perpetuating of said information is performed upon request by relatives, or representatives, or agents of said persons,
(i) said keeping and perpetuating of said information is performed in consideration for an action performed by said persons or agents of said persons,
(j) said keeping and perpetuating of said information is performed as part of a contract, or a commercial transaction, or an agreement with said persons or agents of said persons,
(k) said persons know that said information will be kept and perpetuated, and agree with said keeping and perpetuating of said information;
and wherein the method comprises:
(a) receiving said information about said persons.

2. (canceled)

3. A method of keeping and perpetuating information about one or more persons and making said information available to descendants of said persons and to future generations, wherein one or more of the following conditions are satisfied:
(a) said persons know what said information comprises,
(b) said keeping and perpetuating of said information is performed upon request by said persons,
(c) relatives or agents or representatives of said persons know that said information will be perpetuated,
(d) relatives or agents or representatives of said persons know what said information comprises,
(e) said persons are neither celebrities nor public figures,
(f) society does not have any particular reason to keep and perpetuate information about said persons,
(g) society does not have more reasons to keep and perpetuate information about said persons than to keep and perpetuate information about any other person,
(h) said keeping and perpetuating of said information is performed upon request by relatives, or representatives, or agents of said persons,
(i) said keeping and perpetuating of said information is performed in consideration for an action performed by said persons or agents of said persons,
(j) said keeping and perpetuating of said information is performed as part of a contract, or a commercial transaction, or an agreement with said persons or agents of said persons,
(k) said persons know that said information will be kept and perpetuated, and agree with said keeping and perpetuating of said information;
and wherein the method comprises:
(a) keeping and perpetuating said information as far as possible into the future, or for at least 50 years, or for an unlimited period of time;
(b) keeping account of said information;
(c) making said information available to interested parties into the future or at any time.

4. A method of keeping and perpetuating information and making said information available to future generations, the method comprising:
(a). receiving said information;
(b). keeping and perpetuating said information as far as possible into the future, or for at least 50 years, or for an unlimited period of time;
(c). keeping account of said information;
(d). making said information available to interested parties into the future or at any time;
wherein one or more of the following conditions are satisfied:
(a) said keeping and perpetuating of said information is performed upon request by a party that provides said information, and
(b) said keeping and perpetuating of said information is performed as part of a contract, or a commercial transaction, or an agreement with a party requesting said keeping and perpetuating of said information.

5. The method of claim 1, wherein receiving said information includes at least one of the following: receiving said information via an internet based on-line service, and receiving said information written on paper.

6. The method of claim 3, wherein the information is with respect to at least one of the following: information about the personal life of one or more persons, and medical information concerning one or more persons.

7. The method of claim 3, wherein said information is kept organized in records, wherein each of said records corresponds to one entity such as: one person, a group of persons, an institution, or an event.

8. The method of claim 7, wherein said records contain identifying information of said entity associated with each record;

9. The method of claim 8, wherein said identifying information of said entity associated with the record includes information about at least one of the following: names of the persons, time the persons lived, persons' relatives, persons' descendants, persons' ancestors, related parties, information identifying the records associated with said relatives, information identifying the records associated with said descendants, information identifying the records associated with said ancestors, and information identifying the records associated with said related parties.

10. The method of claim 3, wherein keeping and perpetuating said information includes at least one of the following procedures:
(a) storing said information on one or more data storage media;
(b) making multiple copies of said information and storing said copies on multiple data storage media;
(c) copying said information from a first storage media to a new storage media before the expiration or depreciation of said first storage media;
(d) storing copies of said information on one or more data storage media of one or more types, wherein said types of data storage media are known to last for long time;
(e) keeping said information stored on data storage media which data storage media are further kept in environmental conditions that are known to increase the survival of the data storage media and of the information stored on the data storage media;
(f) making multiple copies of said information, storing said copies on multiple data storage media, and storing said data storage media in multiple places on the earth and in the universe;
(g) surrendering said information to parties capable of further keeping and perpetuating the information.

11. The method of claim 8, wherein keeping account of said information includes at least one of the following methods:
(a) said information is kept accounted for and organized based on the identifying information associated to each record;
(b) said information is made accessible and searchable by digital search engines;
(c) identifying numbers or character strings are associated to each record.

12. The method of claim 3, wherein the information is made available to interested parties by a method comprising at least one of the following:
(a) said information is sent to the interested parties in digital form;
(b) said information is made accessible on-line;
(c) said information is made accessible on-line, searchable based on said identifying information or searchable by search engines.

13. The method of claim 3, wherein said interested parties are provided with a family tree corresponding to said persons.

14. (canceled)

15. The method of claim 3, wherein said persons or their agents and representatives express conditions, desires, or restrictions with respect to making said information available to third parties, and wherein said information is made available to third parties only if making said information available to said third parties satisfies the conditions, or desires, or restrictions expressed by said persons or by agents and representatives of said persons.

16. The method of claim 4, wherein parties that provide said information or their agents and representatives express conditions, desires, or restrictions with respect to making said information available to third parties, and wherein said information is made available to third parties only if making said information available to said third parties satisfies the conditions, or desires, or restrictions expressed by said parties who are providing said information or by their agents and representatives.

17. The method of claim 4, wherein keeping and perpetuating said information includes at least one of the following procedures:
(a) storing said information on one or more data storage media;
(b) making multiple copies of said information and storing said copies on multiple data storage media;
(c) copying said information from a first storage media to a new storage media before the expiration or depreciation of said first storage media;
(d) storing copies of said information on one or more data storage media of one or more types, wherein said types of data storage media are known to last for long time;
(e) keeping said information stored on data storage media which data storage media are further kept in environmental conditions that are known to increase the survival of the data storage media and of the information stored on the data storage media;
(f) making multiple copies of said information, storing said copies on multiple data storage media, and storing said data storage media in multiple places on the earth and in the universe;
(g) surrendering said information to parties capable of further keeping and perpetuating the information.
